(19) United States
(12) Patent Application Publication
(10) Pub. No.: US 2026/0302001 A1
(43) Pub. Date: Oct. 1, 2026

(54) MICRO-NANO GRADIENT MODIFIED HIGH-VOLTAGE OVERHEAD CONDUCTOR FOR ANTI-ICING AND METHOD OF MANUFACTURING SAME

(71) Applicants: State Grid Henan Electric Power Company Electric Power Science Research Institute, Zhengzhou (CN); State Grid Henan Electric Power Company, Zhengzhou (CN); Huazhong University of Science and Technology, Wuhan (CN); Jiangsu Tongguang Transmission LINES Technology Co., Ltd., Nantong (CN); Wuhan Shuneng New Materials Co., Ltd., Wuhan (CN); Guangxi University, Nanning (CN)

(72) Inventors: Jingguang Zhang, Zhengzhou (CN); Jiaxin Wu, Zhengzhou (CN); Zhongbin Lyu, Zhengzhou (CN); Zhongfei Ye, Zhengzhou (CN); Zhimou Xu, Wuhan (CN); Jiabei Lyu, Zhengzhou (CN); Zhi Chen, Wuhan (CN); Haifeng Shi, Nantong (CN); Debiao Xiao, Wuhan (CN); Jingxiang Hu, Wuhan (CN); Hanbo Zheng, Nanning (CN)

(21) Appl. No.: 19/636,023

(22) Filed: Apr. 1, 2026

(30) Foreign Application Priority Data
Apr. 1, 2025 (CN) 202510399344.2

(51) Int. Cl. H01B 17/50; H01B 1/02; H01B 3/00; H01B 9/00; H01B 13/02; H01B 13/16; H01B 13/30; H01B 19/02

(52) U.S. Cl. CPC H01B 17/50; H01B 1/02; H01B 3/006; H01B 9/006; H01B 9/008; H01B 13/0285; H01B 13/0292; H01B 13/165; H01B 13/30; H01B 19/02

(57) ABSTRACT

Provided is a micro-nano gradient modified high-voltage transmission conductor for anti-icing, which includes a transmission conductor and a nano-scale modified layer applied on the surface of the transmission conductor, wherein the transmission conductor is formed by twisting a plurality of wires each surface of which has a micron-sized structure. The wire has circular, square or special-shaped cross-section; the micron-sized structure is manufactured by sandblasting, anodizing, or embossing, composed of interconnected frames and a plurality of micropores each of which is enclosed by the frames, and the angle between each frame and the wire ranges from 110° to 130°, and the surface areas of the micropores account for more than 90% of the total surface area.

### CROSS-REFERENCE TO RELATED APPLICATION

The present application claims priority from Chinese Patent Application No. 202510399344.2 filed on Apr. 1, 2025, the contents of which are incorporated herein by reference in their entirety.

### FIELD OF THE INVENTION

The present invention relates to the technical field of power transmission, in particular to a micro-nano gradient modified high-voltage overhead conductor for anti-icing and method of manufacturing same overhead conductor.

### BACKGROUND OF THE INVENTION

With the continuous growth of global electricity demand and extreme changes in climate conditions, high-voltage overhead conductors are facing increasingly severe challenges. Traditional high-voltage overhead conductors are prone to icing under harsh weather conditions such as ice, snow, and freezing rain, leading to loads increasing on the overhead conductors and even problems such as overhead conductor fracture and tower damage, which severely affect the stability and safety of power transmission. Therefore, how to effectively solve the problem of anti-icing for high-voltage overhead conductor and enhance their resilience against extreme weather has become an urgent technical challenge for the power industry.

In recent years, with rapid development of nanotechnology and surface engineering, anti-icing coatings have been proposed as an effective means to improve the anti-icing performance of high-voltage overhead conductors. By applying anti-icing coating on the surface of high-voltage overhead conductor, the adhesion strength between water droplets, ice, snow, freezing rain and overhead conductor can be significantly reduced,, thereby lessening the load exerted by ice and snow on overhead conductors. The invention patents (application numbers: CN201510802341.5, CN201510790603.0, and CN202010446433.5) have published compositions of anti-icing coatings applicable to overhead conductors. However, although the application of coating technology facilitates an improvement in the anti-icing performance of overhead conductor, three urgent problems exist. Firstly, anti-icing coatings are currently applied manually or by machines at high altitudes, giving rise to low efficiency and difficulty in ensuring consistent effectiveness; secondly, the coatings lack sufficient weather resistance, leading to cracking, failure, and loss of ice-prevention effectiveness over prolonged operation; thirdly, due to insufficient adhesion between coating and conductor, the coating easily detach under the influence of wind, sand, and other factors.

In order to solve the above problems, the present invention proposes to use surface modification technology during overhead conductors manufacturing to give high-voltage overhead conductors intrinsic anti icing performance. The surface modification layer, which exhibits excellent weather resistance, have excellent adhesion strength with the conductor substrate. The present invention effectively overcomes the three major technical difficulties encountered by anti-icing coatings in application.

### SUMMARY OF THE INVENTION

In view of the above problems, the present invention provides a micro-nano gradient modified high-voltage overhead conductor for anti-icing and a method of manufacturing same.

In order to solve the above technical problems, the present invention implements the following technical solution:

A micro-nano gradient modified high-voltage overhead conductor for anti-icing, includes an overhead conductor and a nano-scale modified layer applied on the surface of the overhead conductor, wherein the overhead conductor is formed by twisting a plurality of pieces of wire, each surface of which has a micron-sized structure.

The overhead conductor has a circular cross-section, a square cross-section, or a special-shaped cross-section, and the special-shaped cross-section includes a trapezoidal cross-section and a Z-shaped cross-section, and the micron-sized structure on the surface of the overhead conductor is formed by sandblasting, anodizing, or nano-scale brushed embossing.

The micron-sized structure is composed of interconnected frames and a plurality of micropores enclosed by the frames, and each micropore is in the shape of inverted pyramids, honeycombs, inverted cones, or triangular pyramids, and the angle between each frame and the wire ranges from 110° to 130°, and the surface areas of the micropores account for more than 90% of the total surface area of the wire, and both the length and width of each micropore are 5-800 μm.

The micropores in the micron-sized structure serve as storage sites to provide modification positions for the nano-scale modified layer, and the interconnected frames in the micron-sized structure endow the overhead conductor with enhanced resistance to friction, protecting the nano-scale modified layer from damage during wear; and the nano-scale modified layer enables the overhead conductor to reduce ice coating weight and decrease the adhesion strength between the ice and the conductor.

Furthermore, the nano-scale modified layer is applied on external surfaces of the overhead conductor, wherein the micro-scale structure establishes multiple mechanical interlocking points between the wire and the nano-scale modified layer, thereby enhancing the adhesion strength, wear resistance, and anti-icing performance of the high-voltage conductor.

Furthermore, the overhead conductor is one of aluminum stranded wire, copper stranded wire, aluminum alloy stranded wire, aluminum-clad steel stranded wire, steel-core aluminum stranded wire, and steel stranded wire; and the thickness of the nano-scale modified layer applied on the surface of the overhead conductor is 100 nm to 300 μm, and the nano-scale modified layer is formed by coating a nano-scale modified layer dispersion on the overhead conductor.

Furthermore, the dispersion liquid of the nano-scale modified layer comprises of nanoparticles, organic substance, and solvent; wherein the nanoparticles are silica nanoparticles or titanium oxide nanoparticles, the organic substance is fluorides, polyurethane, or PMMA, and the solvent is isopropanol, ethanol, acetone, DMF, n-butanol, or iso-butanol.

Furthermore, the mass ratio of the nanoparticle, organic substance, and solvent is (5-10): (1-5): (85-95); and the concentration of the isopropanol solvent, ethanol, acetone, DMF, n-butanol, or iso-butanol is higher than 99.5%.

Furthermore, the particle size of the nanoparticles is 1 nm to 200 nm; and the dispersion liquid of the nano-scale modified layer further contains carbon nanotubes, the diameter of which is 1 nm to 200 nm and the length of which is 1 μm to 2 mm.

Furthermore, the concentration of low surface energy substances in the nano-scale modified layer dispersion ranges from 2 mg/mL to 20 mg/mL, and the low surface energy substances in the nano-scale modified layer dispersion are derived from organic substances and nanoparticles.

A method of manufacturing micro-nano gradient modified high-voltage overhead conductor for anti-icing as aforementioned, comprises the following steps.

S1: Preparing micro-structured wire by sandblasting, anodizing, or nano-scale brushed embossing.

S2: Twisting a plurality of pieces of micro-structured wire to manufacture a overhead conductor.

S3: Cleaning and drying the overhead conductor.

S4: Preparing of nano-scale modified layer dispersion.

S5. Uniformly applying nano-scale modified layer dispersion on the surface of the overhead conductor to obtain a high-voltage overhead conductor with hierarchical multi-scale surface.

S6: Performing drying and curing treatment on the applied nano-scale modified layer.

Furthermore, in S4, the step for preparing the dispersion liquid of the nano-scale modified layer includes:

S41: adding the organic substance and the nanoparticles into the solvent while stirring at a speed of less than 100 rpm; the mass ratio of the nanoparticles, organic substance, and solvent is (5-10): (1-5): (85-95);

S42: performing ultrasonic dispersion or high-speed stirring on a mixture solution obtained in S41, wherein the ultrasonic dispersion is performed on the mixture solution at 20 kHz ×30 min; the high-speed stirring is performed on the mixture solution at 2000-2500 rpm×30 min, so as to prepare the dispersion liquid of the nano-scale modified layer;

S43: removing the agglomerate of big particles from the dispersion liquid of the nano-scale modified layer obtained in step S42 by means of centrifugation or filtration, so as to obtain a uniform and stable dispersion liquid of the nano-scale modified layer.

Furthermore, in S5, the way for applying the dispersion liquid of the nano-scale modified layer onto the overhead conductor includes spraying, dipping, or brushing, and a specific step for employing spraying includes:

S51: setting the nozzle translation speed of the spray gun to 50-500 mm/s and the nozzle temperature to 20-200° C.;

S52: starting the spraying device and uniformly applying the dispersion liquid of the nano-scale modified layer on the surface of the overhead conductor;

S53: cooling and curing the high-voltage overhead conductor formed after uniformly applying the dispersion liquid, wherein the cooling lasts 5-100 s.

Compared with the prior art, the micro-nano gradient modified high-voltage overhead conductor for anti-icing and the method of manufacturing same provided by the present invention have the following beneficial effects.
(1) By forming a micron-sized structure on the surface of the overhead conductor, the adhesion and wear resistance of the nano-scale modified layer is significantly enhanced. The micron-sized structure enhances the stability of coatings, avoiding detachment or wear problems caused by insufficient adhesion, significantly reducing the maintenance and replacement frequency, and decreasing subsequent maintenance costs.
(2) By combining the micron-scale structure with the nano-scale modified layer, the high-voltage overhead conductor is enabled to have multiple functions such as superhydrophobic, superoleophobicity, ultra ice-resistance, anti-freezing rain, anti-icing, anti-fouling, and self-cleaning. These functions enable the overhead conductor to present excellent protective capabilities under harsh environmental conditions, thereby effectively preventing the adhesion and accumulation of water droplets, ice, snow, rain, etc., reducing the load applied on the overhead conductor, and ensuring the stability and safety of the power transmission system in severe weather.
(3) The present invention combines nano-scale brushed embossing and nanoscale modification layer technology, which not only improves the anti-icing performance of high-voltage overhead conductors, but also features low cost and high production efficiency, suitable for large-scale industrial production. Compared with traditional methods for preparing micron-sized structures, the preparation process of the present invention is simple, low-cost, and highly efficient, and capable of meeting the requirements of industrial applications, and further promotes widespread application of nano-scale modified layers in the field of power transmission.
(4) The technical solution provided by the present invention can significantly improve the operational reliability of high-voltage overhead conductor in extreme weather conditions. Through the synergistic effect of micro-scale structure and coating, conductors can maintain good power transmission performance in harsh environments such as high humidity, low temperature, and high wind speed, reduce conductor failures caused by factors such as icing, and improve the overall stability of power transmission. This technology provides effective technical support for the safe and stable operation of high-voltage transmission lines.

### BRIEF DESCRIPTION OF THE DRAWINGS

In order to more clearly illustrate the technical solutions in embodiments or in the prior art, we shall briefly describe the figures for the embodiments or the prior art as follows. Obviously, the figures described as follows are only for the sake of some embodiments of the present invention, and a person skilled in the art can also obtain other figures based on these figures without any inventive work.

FIG. 1 is a diagram of the method of manufacturing the micro-nano gradient modified high-voltage overhead conductor for anti-icing, according to the present invention.

FIG. 2 is a cross-sectional diagram of the micro-nano gradient modified high-voltage overhead conductor for anti-icing, according to the present invention.

### DETAILED DESCRIPTION OF SOME EMBODIMENTS

We shall clearly and completely describe technical solutions in some embodiments of the present invention in combination with the figures in some embodiments of the present invention. Obviously, the described embodiments are only part of embodiments of the present invention, not all the embodiments. Based on some embodiments in the present invention, all other embodiments obtained by a person skilled in the art without any inventive work fall within the protection scope of the present invention.

### EMBODIMENT 1

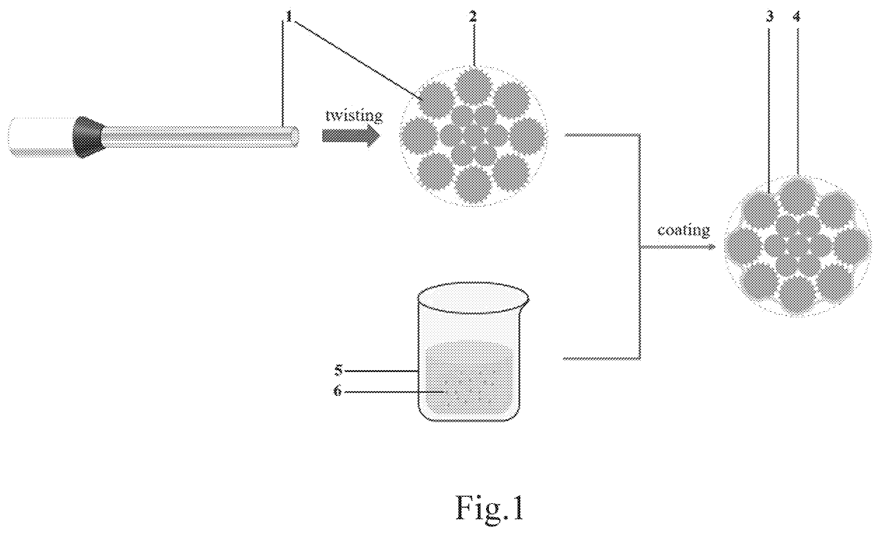

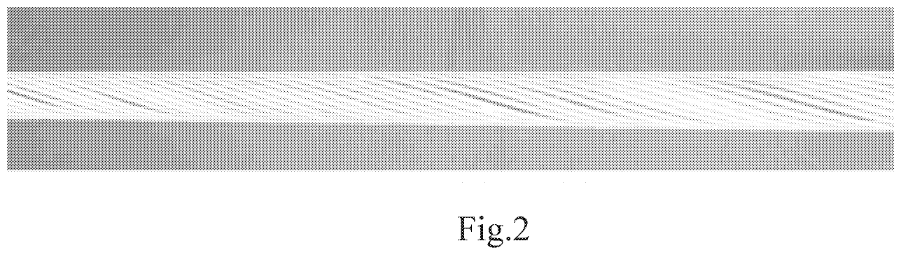

As shown in FIGS. 1-2, an embodiment of the present invention provides a micro-nano gradient modified high-voltage overhead conductor for anti-icing 4 and a method of manufacturing same.

A micro-nano gradient modified high-voltage overhead conductor for anti-icing 4, includes an overhead conductor 2 and a nano-scale modified layer 3 applied on the surface of the overhead conductor 2. The overhead conductor 2 is formed by twisting a plurality of pieces of wire 1, each surface of which has a micron-sized structure.

The wire 1 has a circular cross-section, a square cross-section, or a special-shaped cross-section, and the special-shaped cross-section includes a trapezoidal cross-section, a Z-shaped cross-section and other special-shaped cross-sections. The micron-sized structure on the surface of the wire is formed by sandblasting, anodizing, or nano-scale brushed embossing. In the present invention, it is possible to employ any one means among sandblasting, anodizing and nano-scale brushed embossing to finely process the wire, so as to prepare the micron-sized structure on the surface of the wire. The wire can be manufactured by means of wire drawing, electrodeposition, melt spinning, or chemical vapor deposition.

In the case of employing the means of sandblasting to prepare the micron-sized structure on the surface of the wire, the specific process is as follows.

Sandblasting treatment applied on the wire includes: selecting an abrasive particle, which may be an aluminum oxide particle or a silicon carbide particle; setting parameters of a sandblasting device, which involve blasting pressure, blasting angle, and blasting distance; fixing the wire on a workbench of the sandblasting device; and starting sandblasting and making the abrasive particles to collide with the surface of the wire at high speed to form micron-sized structures.

Cleaning and inspection include: cleaning the surface of the wire by using an ultrasonic cleaning device or a high-pressure water gun to remove residual abrasive particles; and inspecting the micron-sized structures on the surface of the wire by microscope to judge whether reaching the desired effect.

In the case of employing the means of anodizing to prepare the micron-sized structure on the surface of the wire, the specific process is as follows (this means is only employed to form micron-sized structures on the surface of the wire made from aluminum or its alloy).

Pre-treatment includes: cleaning the surface of the wire to remove grease, dust, and other impurities and performing polishing or sandblasting to make a more uniform surface.

Anodizing treatment includes: using the wire as an anode and placing it into an electrolyte, which contains sulfuric acid, chromic acid, or oxalic acid; setting electrolysis parameters, which involve current density, voltage, and electrolysis time; and starting anodizing and generating oxide film on the surface of the wire to form micro-sized structures.

Post-treatment includes: rinsing the surface of the wire with deionized water to remove residual electrolytes; and examining the micron-sized structures on the surface of the wire by microscope to judge whether reaching the desired effect.

In this embodiment, it is possible to further process the wire by employing the means of nano-scale brushed embossing, the steps of which are described in the subsequent text.

In addition, the micron-sized structure is composed of interconnected frames and a plurality of micropores each of which is enclosed by the frames, and each micropore is in the shape of inverted pyramids, honeycombs, inverted cones, or triangular pyramids. An angle between each frame and the wire ranges from 110° to 130°. The surface areas of the micropores account for more than 90% of the total surface area of the wire, and both the length and width of each micropore are 5-800 μm.

The micropores in the micron-sized structure serve as a storage site to provide a modification endow the overhead conductor with enhanced resistance to friction, protecting the nano-scale modified layer from damage during wear. The nano-scale modified layer enables the overhead conductor to reduce ice coating weight and decrease the binding force between the ice and the conductor.

The nano-scale modified layer 3 is applied on external surfaces of the overhead conductor 2. The micron-sized structure is configured to form a plurality of mechanical interlocking points between the wire 1 and the nano-scale modified layer 3, in order to increase the binding force between the nano-scale modified layer 3 and the overhead conductor 2, and improve wear resistance of the nano-scale modified layer 3, and anti-icing properties of the high-voltage overhead conductor.

Specifically, the micro-scale structure serves to enhance the binding force and wear resistance of the nano-scale modified layer 3. The overhead conductor 2, made by twisting the pieces of micro-scale wire 1 prepared by means of nano-scale brushed embossing is selected from the group consisting of aluminum stranded wire, copper stranded wire, aluminum alloy stranded wire, aluminum-clad steel stranded wire, steel-core aluminum stranded wire, and steel stranded wire.

The cross-sectional size of the overhead conductor 2 ranges from 10 mm to 50 mm. The thickness of the nano-scale modified layer 3 applied on the surface of the overhead conductor 2 is 100 nm to 300 μm. The nano-scale modified layer 3 is formed by applying the dispersion liquid 5 on the electricity transmission cable 2.

In addition, the dispersion liquid 5 consists of nanoparticles, organic substances, and solvent, among which the nanoparticle is silica nanoparticle or titanium oxide nanoparticle, the organic substance is fluorides, polyurethane, or PMMA, and the solvent is isopropanol, ethanol, acetone, DMF, n-butanol, or iso-butanol.

The mass ratio of the nanoparticle, organic substance, and solvent is (5-10): (1-5): (85-95); and the concentration of the isopropanol, ethanol, acetone, DMF, n-butanol, or iso-butanol is higher than 99.5%. The particle size of the nanoparticle is 1 nm to 200 nm; and the dispersion liquid 5 further contains carbon nanotubes with a diameter of 1 nm to 200 nm and a length of 1 μm to 2 mm.

The concentration of low surface energy substance in the dispersion liquid 5 ranges from 2 mg/mL to 20 mg/mL, and the low surface energy substance of the dispersion liquid 5 derives from nanoparticles and organic substances. In this embodiment, the concentration range of the low surface energy substance can be determined by surface tension method, contact angle measurement, or chromatography.

This embodiment further provides a method of manufacturing micro-nano gradient modified high-voltage overhead conductor for anti-icing 4 as aforementioned, comprising the following steps.
S1: Preparing a piece of micro-structured wire 1 by sandblasting, anodizing, or nano-scale brushed embossing.
S2: Twisting a plurality of pieces of the micro-structured wire 1 to manufacture overhead conductor 2.
S3: Cleaning and drying the overhead conductor 2.
S4: Preparing the dispersion liquid 5.
S5. Uniformly applying the dispersion liquid 5 on the surface of the overhead conductor 2 to obtain a high-voltage overhead conductor with hierarchical multi-scale surface.
S6: Performing drying and curing treatment on the applied nano-scale modified layer 3.

It should be noted that the aforementioned micro-structured wire refers to a wire with micron-sized structures on its surface.

In S1, the preparing process a piece of micro-structured wire 1 via nano-scale brushed embossing, includes the following steps: Mold Design: Based on the required microstructure design, fabricate the desired microstructure pattern on a mold material (e.g., silicon, silicon dioxide, or polydimethylsiloxane) using electron beam lithography (EBL) or other high-precision lithography techniques. Mold Treatment: Perform a hydrophobic treatment on the mold surface to ensure easy separation from the metal material during the embossing process. Metal Material Preparation: Select a metal material suitable for wire drawing and embossing, followed by cleaning and pre-treatment to remove surface impurities and oxide layers. Embossing Adhesive Coating and Molding: Apply a layer of embossing adhesive to the surface of the metal material, press the mold onto the adhesive layer, and apply controlled pressure and temperature to ensure the adhesive fully fills the microstructure pattern on the mold. Adhesive Curing: Cure the embossing adhesive using ultraviolet irradiation or alternative methods to form a microstructure that replicates the mold pattern. Mold Release: Gently peel the mold away from the metal material surface to ensure complete transfer of the microstructures onto the metal surface. Wire Drawing: Subject the microstructure-patterned metal material to wire drawing treatment, gradually reducing its diameter to form micro-structured wire 1.

In S4, a step for preparing the dispersion liquid 5 includes:

S41: adding the organic substances and the nanoparticles into the solvent while stirring at a speed of less than 100 rpm; the mass ratio of the nanoparticle, organic substance, and solvent is (5-10): (1-5): (85-95);

S42: performing ultrasonic dispersion or high-speed stirring to the mixture solution obtained in S41; For ultrasonic dispersion, apply a frequency of 20 kHz for 30 minutes; for high-speed stirring, operate at a rotational speed of 2000-2500 rpm for 30 minutes, thereby preparing the dispersion liquid 5 of the nano-scale modified layer;

S43: removing the agglomerate of big particles from the dispersion liquid 5 obtained in step S42 by means of centrifugation or filtration, so as to obtain a uniform and stable dispersion liquid 5.

Furthermore, in S5, the method for applying the dispersion liquid 5 onto the overhead conductor 2 includes spraying, dipping, or brushing, and a specific step for employing the means of spraying includes:

S51: setting the nozzle translation speed of the spray gun to 50-500 mm/s and the nozzle temperature to 20~200° C.;

S52: starting the spraying device and uniformly applying the dispersion liquid 5 on the surface of the overhead conductor 2 through the spraying nozzle.

S53: cooling and curing the high-voltage overhead conductor formed after uniformly applying the dispersion liquid, wherein the cooling lasts 5-100 s.

In the present invention, regarding microstructure design, the nanos-cale modified layer 3 adopts a micro-nano composite structure, where nano-scale particles are further coated onto a micron-scale rough structure. This structure can significantly increase surface roughness, thereby enhancing water resistance and oil resistance. In addition, since the power overhead conductor 2 of the present invention is formed by twisting multiple micro-structured wires prepared via nano-scale brush embossing, the synergistic effect of this inherent microstructure and the nano-coating further amplifies surface roughness and water resistance. In terms of chemical properties, the nanoparticles used in the present invention have an extremely high specific surface area, which can effectively reduce surface energy and render the coating surface resistant to wetting by water or oil. The organic component also features low surface energy, which further reduces the surface energy of the coating and enhances its water and oil resistance. The solvent serves to uniformly disperse the nanoparticles and organic component, forming a homogeneous coating. After drying, the solvent evaporates, leaving a stable nanostructure. Furthermore, the combination of the coating's low surface energy and the micro-nano composite structure create a “lotus leaf effect”: water droplets form spherical shapes on the surface, roll off easily, and carry away adhering dust and dirt, thereby achieving a self-cleaning function.

### EMBODIMENT 2

This embodiment provides a further description to the method of manufacturing micro-nano gradient modified high-voltage overhead conductor for anti-icing 4, based on Embodiment 1.

A method of manufacturing the micro-nano gradient modified high-voltage overhead conductor for anti-icing 4, includes the following steps.

S1: Preparing a piece of micro-structured aluminum wires 1 with a diameter of 4.22 mm by nano-scale brushed embossing, wherein the microporous of the micron-sized structure on the surface of the aluminum wire is V-shaped and recurs at a regular interval of 200 μm.

S2: Twisting a plurality of pieces of micro-structured aluminum wire 1 with a diameter of 4.22 obtained in S1 to make a circular steel-core aluminum overhead conductor with a diameter of 33.75 mm.

S3: Preparing the dispersion liquid 5 of the nano-scale modified layer, which consists of modified nano silicon dioxide, acrylate, titanium dioxide, epoxy resin, additives, and n-butyl acetate, wherein the particle size of the modified nano silicon dioxide is 10-20 nm.

S4: Applying the dispersion liquid 5 on the surface of the overhead conductor 2 by spraying to obtain the micro-nano gradient modified high-voltage overhead conductor for anti-icing 4. The spraying process is controlled with the following parameters: the nozzle diameter of 1-1.3 mm, the spraying pressure of not less than 0.5 MPa, and the spraying distance of 15-20 cm. The spraying is performed in two passes to form the nanoscale modified layer 3 with a thickness of 100 μm. The cross-section of the micro-nano gradient modified high-voltage power overhead conductor for anti-icing 4 is illustrated in FIG. 2.

### EMBODIMENT 3

This embodiment provides a further description to a method of manufacturing the micro-nano gradient modified high-voltage overhead conductor for anti-icing 4, based on Embodiment 1.

A method of manufacturing the micro-nano gradient modified high-voltage overhead conductor for anti-icing 4, includes the following steps.

S1: Preparing a piece of micro-structured aluminum wire 1 with a diameter of 4.22 mm by nano-scale brushed embossing, wherein the microporous of the micron-sized structure on the surface of the aluminum wire is trapezoidal and recurs at a regular interval of 500 μm.

S2: Twisting a plurality of pieces of micro-structured aluminum wires 1 with a diameter of 4.22 obtained in S1 to make a circular steel-core aluminum overhead conductor with a diameter of 33.75 mm.

S3: Preparing the dispersion liquid 5, which consists of modified nano silicon dioxide, acrylate, titanium dioxide, epoxy resin, additives, and n-butyl acetate, wherein the particle size of the modified nano silicon dioxide is 10-20 nm.

S4: Applying the dispersion liquid 5 on the surface of the overhead conductor 2 by dipping to obtain the micro-nano gradient modified high-voltage overhead conductor for anti-icing 4, having the nanoscale modification layer 3, which is 50 μm in thickness.

### EMBODIMENT 4

This embodiment provides a further description to a method of manufacturing micro-nano gradient modified high-voltage overhead conductor for anti-icing 4, based on Embodiment 1.

A method of manufacturing micro-nano gradient modified high-voltage overhead conductor for anti-icing 4, includes the following steps.

S1: Preparing a piece of micro-structured aluminum wire 1 with a diameter of 4.22 mm by nano-scale brushed embossing, wherein the microporous of the micron-sized structure on the surface of the aluminum wire is arc-shaped and recurs at a regular interval of 200 μm.

S2: Twisting a plurality of pieces of micro-structured aluminum wires 1 with a diameter of 4.22 mm obtained in S1 to make a circular steel-core aluminum overhead conductor with a diameter of 33.75 mm.

S3: Preparing a dispersion liquid 5 of the nano-scale modified layer, which consists of nano silicon dioxide, nano aluminum oxide, nano titanium dioxide, multi-walled carbon nanotubes, binders, surface additives, and ethanol, wherein the particle size of the nano silicon dioxide is 10-100 nm; the particle size of the nano aluminum oxide is 10-150 nm; the particle size of the nano titanium dioxide is 10-100 nm; and the diameter of the multi-walled carbon nanotubes is 10-100 nm.

S4: Applying the dispersion liquid 5 on the surface of the overhead conductor 2 by spraying to obtain the micro-nano gradient modified high-voltage overhead conductor for anti-icing 4. The spraying process is controlled with the following parameters: a nozzle diameter of 1-1.3 mm, a spraying pressure of no less than 0.5 MPa, and a spraying distance of 15-20 cm. The spraying operation is performed in two passes to form the 75 μm-thick nanoscale modification layer 3.

### EMBODIMENT 5

This embodiment provides a further description to a method of manufacturing the micro-nano gradient modified high-voltage overhead conductor for anti-icing 4, based on Embodiment 1.

A method of manufacturing the micro-nano gradient modified high-voltage overhead conductor for anti-icing 4, includes the following steps.

S1: Preparing a piece of micro-structured aluminum wire 1 with a diameter of 4.22 mm by nano-scale brushed embossing, wherein the microporous of the micron-sized structure on the surface of the aluminum wire is V-shaped and recurs at a regular interval of 300 μm.

S2: Twisting a plurality of pieces of micro-structured aluminum wires 1 with a diameter of 4.22 mm obtained in S1 to make a circular steel-core aluminum overhead conductor with a diameter of 33.75 mm.

S3: Preparing a dispersion liquid 5 of the nano-scale modified layer, which consists of nano silicon dioxide, nano aluminum oxide, nano titanium dioxide, multi-walled carbon nanotubes, binders, surface additives, and ethanol, wherein the particle size of the nano silicon dioxide is 10-100 nm; the particle size of the nano aluminum oxide is 10-150 nm; the particle size of the nano titanium dioxide is 10-100 nm; and the diameter of the multi-walled carbon nanotubes is 10-100 nm.

S4: Applying the dispersion liquid 5 on the surface of the overhead conductor 2 by brushing to obtain the micro-nano gradient modified high-voltage overhead conductor for anti-icing 4, with a 200 μm-thick nanoscale modification layer 3.

### EMBODIMENT 6

This embodiment provides a further description to a method of manufacturing the micro-nano gradient modified high-voltage overhead conductor for anti-icing 4, based on Embodiment 1.

A method of manufacturing the high-voltage micro-nano gradient modified high-voltage overhead conductor for anti-icing 4, includes the following steps.

S1: Preparing a piece of micro-structured aluminum wire 1 with a diameter of 4.22 mm by nano-scale brushed embossing, wherein the microporous of the micron-sized structure on the surface of the aluminum wire is trapezoidal and recurs at a regular interval of 500 μm.

S2: Twisting a plurality of pieces of micro-structured aluminum wires 1 with a diameter of 4.22 mm obtained in S1 to make a circular steel-core aluminum overhead conductor with a diameter of 33.75 mm.

S3: Preparing a dispersion liquid 5 of the nano-scale modified layer, which consists of water-resistant nano silicon dioxide, water-resistant glass fiber, epoxy resin, curing agents, and ethyl acetate, wherein the particle size of the water-resistant nano silicon dioxide is 15-30 nm.

S4: Applying the dispersion liquid 5 on the surface of the overhead conductor 2 by spraying to obtain the micro-nano gradient modified high-voltage overhead conductor for anti-icing 4. The spraying process is controlled with the following parameters: a nozzle diameter of 1-1.3 mm, a spraying pressure of no less than 0.5 MPa, and a spraying distance of 15-20 cm. The spraying operation is performed in two passes to form the 50 μm-thick nanoscale modification layer 3.

### EMBODIMENT 7

This embodiment provides a further description to a method of manufacturing the micro-nano gradient modified high-voltage overhead conductor for anti-icing 4, based on Embodiment 1.

A method of manufacturing the micro-nano gradient modified high-voltage overhead conductor for anti-icing 4, includes the following steps.

S1: Preparing a piece of micro-structured aluminum wire 1 with a diameter of 2.47 mm by nano-scale brushed embossing, wherein the microporous of the micron-sized structure on the surface of the aluminum wire is V-shaped and recurs at a regular interval of 100 μm.

S2: Twisting a plurality of pieces of micro-structured aluminum wires 1 with a diameter of 2.47 mm obtained in S1 to make a circular steel-core aluminum overhead conductor with a diameter of 33.75 mm.

S3: Preparing a dispersion liquid 5 of the nano-scale modified layer, which consists of water-resistant nano silicon dioxide, water-resistant glass fiber, epoxy resin, curing agents, and ethyl acetate, wherein the particle size of the water-resistant nano silicon dioxide is 15-30 nm.

S4: Applying the dispersion liquid 5 on the surface of the overhead conductor 2 by spraying to obtain the micro-nano gradient modified high-voltage overhead conductor for anti-icing 4. The spraying process is controlled with the following parameters: a nozzle diameter of 1-1.3 mm, a spraying pressure of no less than 0.5 MPa, and a spraying distance of 15-20 cm. The spraying operation is performed in two passes to form the 50 μm-thick nanoscale modification layer 3.

The above examples are merely preferred embodiments of the present invention, and do not impose any limitation on the protection scope of the present invention. It is understandable for a person skilled in the art that any changes, modifications, substitutions, and variations can be made to these embodiments without departing from the principle and essence of the present invention and fall within the protection scope of the present invention. It should be noted that a person skilled in the art can make a variety of improvements and modifications without departing from the principles of the present invention; therefore, the scope of the present invention is defined by the appended claims and their equivalents.

### DESCRIPTION OF SYMBOLS

1—wire; 2—overhead conductor; 3—nano-scale modified layer; 4—micro-nano gradient modified high-voltage overhead conductor for anti-icing; 5—dispersion liquid of the nano-scale modified layer; 6—nano water-resistant particle.

What is claimed is:

1. A micro-nano gradient modified high-voltage overhead conductor for anti-icing, comprising an overhead conductor and a nano-scale modified layer applied on the surface of the overhead conductor;
wherein the overhead conductor is formed by twisting a plurality of wires each surface of which has a micron-sized structure;
wherein the wire has a circular cross-section, a square cross-section, or a special-shaped cross-section, and the special-shaped cross-section includes a trapezoidal cross-section and a Z-shaped cross-section, and the micron-sized structure on the surface of the wire is formed by sandblasting, anodizing, or nano-scale brushed embossing;
wherein the micron-sized structure is composed of interconnected frames and a plurality of micropores each of which is enclosed by the frames, and each micropore is in the shape of inverted pyramids, honeycombs, inverted cones, or triangular pyramids, and an angle between each frame and the wire ranges from 110° to 130°, and the surface areas of the micropores account for more than 90% of the total surface area of the wire, and both the length and width of each micropore are 5-800 μm;
wherein the micropores in the micron-sized structure serve as storage sites to provide a modification positions for the nano-scale modified layer, and the interconnected frames in the micron-sized structure endow the overhead conductor with enhanced resistance to friction, protecting the nano-scale modified layer from damage during wear; and the nano-scale modified layer enables the overhead conductor to reduce ice coating weight and decrease the binding force between the ice and the wire.

2. The micro-nano gradient modified high-voltage overhead conductor for anti-icing according to claim 1, wherein the nano-scale modified layer is applied on external surfaces of the overhead conductor, wherein the micro-scale structure establishes multiple mechanical interlocking points between the wire and the nano-scale modified layer, thereby enhancing the bonding strength, wear resistance, and anti-icing performance of the high-voltage conductor.

3. The micro-nano gradient modified high-voltage overhead conductor for anti-icing according to claim 2, wherein the overhead conductor is one of aluminum stranded wire, copper stranded wire, aluminum alloy stranded wire, aluminum-clad steel stranded wire, steel-core aluminum stranded wire, and steel stranded wire; and the thickness of the nano-scale modified layer applied on the surface of the overhead conductor is 100 nm to 300 μm, and the nano-scale modified layer is formed by applying a dispersion liquid of the nano-scale modified layer on the overhead conductor.

4. The micro-nano gradient modified high-voltage overhead conductor for anti-icing according to claim 3, wherein the dispersion liquid of the nano-scale modified layer comprises of nanoparticle, organic substance, and solvent, wherein the nanoparticles are silica nanoparticles or titanium oxide nanoparticles, the organic substance is fluorides, polyurethane, or PMMA, and the solvent is isopropanol, ethanol, acetone, DMF, n-butanol, or iso-butanol.

5. The micro-nano gradient modified high-voltage overhead conductor for anti-icing according to claim 4, wherein the mass ratio of the nanoparticle, organic substance, and solvent is (5-10): (1-5): (85-95); and the concentration of the isopropanol solvent, ethanol, acetone, DMF, n-butanol, or iso-butanol is higher than 99.5%.

6. The micro-nano gradient modified high-voltage overhead conductor for anti-icing according to claim 5, wherein the particle size of the nanoparticle is 1 nm to 200 nm; and the dispersion liquid of the nano-scale modified layer further contains carbon nanotubes, the diameter of which is 1 nm to 200 nm and the length of which is 1 μm to 2 mm.

7. The micro-nano gradient modified high-voltage overhead conductor for anti-icing according to claim 6, wherein the concentration of low surface energy substances in the nano-scale modified layer dispersion modified layer ranges from 2 mg/mL to 20 mg/mL, and the low surface energy substances in the nano-scale modified layer dispersion are derived from the organic substances and the nanoparticles.

8. A method of manufacturing the micro-nano gradient modified high-voltage overhead conductor for anti-icing as claimed in claim 1, comprising the steps of
S1: preparing a piece of micro-structured wire by sandblasting, anodizing, or nano-scale brushed embossing;
S2: twisting a plurality of pieces of the micro-structured wires to manufacture a overhead conductor;
S3: cleaning and drying the overhead conductor;
S4: preparing a dispersion liquid of the nano-scale modified layer;
S5. uniformly applying the dispersion liquid of the nano-scale modified layer on the surface of the overhead conductor to obtain a high-voltage overhead conductor with a hierarchical multi-scale surface;
S6: performing drying and curing treatment on the applied nano-scale modified layer.

9. The method according to claim 8, wherein in S4, a step for preparing the dispersion liquid of the nano-scale modified layer includes the sub-steps of
S41: adding the organic substance and the nanoparticles into the solvent while stirring at a speed of less than 100 rpm; the mass ratio of the nanoparticles, organic substance, and solvent, is (5-10): (1-5): (85-95);
S42: performing ultrasonic dispersion or high-speed stirring on the mixture solution obtained in S41, wherein the ultrasonic dispersion is performed on the mixture solution at 20 kHz×30 min; the high-speed stirring is performed on the mixture solution at 2000-2500 rpm×30 min, so as to prepare the dispersion liquid of the nano-scale modified layer;
S43: removing the agglomerate of big particles from the dispersion liquid of the nano-scale modified layer obtained in step S42 by means of centrifugation or filtration, so as to obtain a uniform and stable dispersion liquid of the nano-scale modified layer.

10. The method according to claim 9, wherein in S5, the way for applying the dispersion liquid of the nano-scale modified layer onto the overhead conductor includes spraying, dipping, or brushing, and a specific step for employing the means of spraying includes:
S 51: setting the nozzle translation speed of the spray gun to 50-500 mm/s and the nozzle temperature to 20~200° C.;
S52: starting the spraying device and uniformly applying the dispersion liquid of the nano-scale modified layer on the surface of the overhead conductor;
S53: cooling and curing the high-voltage overhead conductor formed after uniformly applying the dispersion liquid, wherein the cooling lasts 5-100 s.
